(19) United States
(12) Patent Application Publication
(10) Pub. No.: US 2007/0087606 A1
(43) Pub. Date: Apr. 19, 2007

(54) Sealing Member and System

(75) Inventors: Gad Shelef, Mountain View, CA (US); Shmuel Erez, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: g2 ENGINEERING, INC., Mountain View, CA (US)

(21) Appl. No.: 11/419,302

(22) Filed: May 19, 2006

Related U.S. Application Data
(63) Continuation-in-part of application No. 11/249,907, filed on Oct. 14, 2005.

(51) Int. Cl. H01R 13/52

(52) U.S. Cl. 439/274

(57) ABSTRACT

A sealing system comprises a pair of clamping members and a sealing member between them. The sealing member is defined by a generatrix following a closed-loop curve around a longitudinal axis. In a cross-section in a plane that includes the longitudinal axis, the generatrix of the sealing member can have a substantially diagonal orientation between the clamping members. When an axial clamping force is applied, the clamping force is converted by the sealing member into a compression force that is greater than the clamping force along the generatrix.

This is a continuation-in-part of U.S. patent application Ser. No. 11/249,907, filed on Oct. 14, 2005, which is incorporated herein by reference.

### FIELD OF THE INVENTION

At least one embodiment of the present invention pertains to sealing devices, and more particularly, to metallic sealing of the joints between surfaces, such as the end flanges by which a pressurized content of a vessel, cylinder, etc. is separated and sealed from the surrounding atmosphere or from another pressurized medium.

### BACKGROUND

Sealing devices are commonly used for metallic sealing of the joints between surfaces, such as the end flanges by which a pressurized content of a vessel, cylinder, etc. is separated and sealed from the surrounding atmosphere or from another pressurized medium. In such assemblies the flanges are normally connected together by studs, or bolts with nuts, or wedged together by other rings. A sealing assembly may find application in high-pressure or high-vacuum systems where leakage of the medium may be critical.

There exists a great variety of sealing assemblies and systems for sealing containers or vessels that are filled with a gaseous or liquid media under high-pressure or high-vacuum and that are closed and sealed via interconnection of two flanged elements fixed to each other by bolts or studs with nuts. For example, U.S. Pat. No. 5,669,612 issued in 1997 to T. Nicholson describes a sealing assembly that contains an API (American Petroleum Institute) groove seal in the form of a metal ring of cross-section like a capital Greek letter omega arranged so that the tips of its limbs provide the sole contact with the groove base before and after compression. The central or heel region may abut on the outer side wall of the groove. A family of seals for different pressure ratings has a common profile, differing only in respect of the thickness of the limbs. These seals were specified by API for sealing pipeline flange joints by location in opposed grooves in the flange faces. The standard API groove cross-section is a symmetrical trapezium, receiving an octagonal sealing ring.

U.S. Pat. No. 6,409,180 issued in 2002 to J. Spence et al. discloses a metallic seal assembly with a metallic seal that concentrates the available load over a narrow band to produce a sealing dam over a sufficient width to minimize leakage on a molecular level. The metallic seal has a first annular beam section, a second annular beam section, and inner and outer surfaces extending between the first and second annular beam sections. One of the inner and outer surfaces has an annular recess that at least partially defines an annular column section of material extending substantially perpendicular between said first and second annular beam sections thereto. The first annular beam section has a first non-sealing surface and a first raised portion with a first annular sealing surface facing in a first axial direction to contact a first member for creating a first annular sealing dam therebetween. The second annular beam section has a second non-sealing surface and a first raised portion with a second annular sealing surface facing in a second axial direction, which is opposite to the first axial direction, to contact a second member for creating a second annular sealing dam therebetween. The annular inner surface extends between the first and second sealing surfaces to form a central passageway. The metallic seal is used to create a seal between a pair of mating surfaces of a first member and a second member. First and second members are coupled together by a plurality of fasteners or bolts. By tightening the fasteners the seal is loaded, and thus, compressed to plastically deform on a micro-scale and create an annular seal between the first and second members.

U.S. Patent Application Publication no.2002/0117814A1 published in 2002 (inventor H. Halling, et al.) relates to a resilient seal that has an annular curved region having a generally C-shaped cross section, and a pair of annular leg regions. Each leg region has a free end and extends generally radially inward towards the inside of the C-shaped cross section. The leg regions contact each other and each form a generally frusto-conical disk spring member extending inwardly from the curved region. The leg regions are adapted to contact each other and to provide a restoring force when the sealing ring is compressed. A first bend connects one of said leg regions to the curved region, and a second bend connects the other of the leg regions to the curved region.

U.S. Patent Application Publication no. 2005/0023769A1 published in 2005 (inventor H. Halling) relates to a resilient, annular, metallic seal member having a generally “j” shaped cross-section The annular, metallic seal member includes a first end portion having a first distal end, a generally curled second end portion that extends to a second distal end, and a central body portion between and contiguous with the first and second end portions. The annular, metallic seal member has a first side and an opposite second side. The second end portion curls in a first direction in accordance with a predetermined radius such that the second distal end is located across from the first side of the annular, metallic seal member and the first and second distal ends do not face each other.

Published U.K. Patent Application no. 2375575 published in 2002 (inventor R. Quoiani) relates to a sealing assembly with a compressible metallic sealing element that has a hollow wall of concertina or bellows shaped filled with an easily-deformable, relatively-incompressible substance such that axial compression of the seal causes the seal to bulge transversely and thus to seal the connection. The seal may be used between a casing string and a tube hanger in oil or gas wells. Although in this device a sealing force is to some extent amplified by the geometry of the seal and flanges, this amplification is very small. The seal has a complicated configuration and in the case of ultra-high vacuum will produce a large dead volume that may create a virtual leakage. Virtual leak comes into play at ultra-high vacuum. Since it is not leaking from the outside, but from the entrapped volume, its source is not detectable by introducing helium around the vessel. The higher the vacuum, the longer it would take this leak to diminish.

A common disadvantage of all sealing systems known to the applicants, including those described above, is that they either have a complicated shape or complicated design composed of several components. Therefore, the known sealing systems are expensive in manufacture and complicated in assembling and maintenance. Furthermore, the structure of known sealing assemblies cannot provide conversion of flange tightening force into amplified sealing force but rather squeezes the seal without protection against leakage through the area of interface between the side walls of the seal and the mating surfaces of the flanges, or the like.

### SUMMARY OF THE INVENTION

The present invention includes a sealing member to establish a seal between a pair of clamping members, where the sealing member has a geometry such that the sealing member forms a closed loop about a longitudinal axis, such that the sealing member forms a seal on a sealing surface of each of the clamping members when the sealing member is engaged between the clamping members and a clamping force is applied parallel to the longitudinal axis. The geometry of the sealing member further is such that the sealing member causes a compression force which is greater than the clamping force to be applied between the sealing member and the sealing surface of each clamping member when the clamping force is applied. The sealing member has a cross-sectional length in a plane which includes the longitudinal axis, and the sealing member is capable of plastic deformation along substantially that entire cross-sectional length in response to the clamping force.

In another aspect of the invention, a sealing member to establish a seal between a pair of clamping members has a geometry such that, when the sealing member is engaged between the clamping members and a clamping force is applied, the sealing member engages, on each of the clamping members, a clamping surface which moves toward the clamping surface of the other clamping member, and such that the sealing member forms a seal on a sealing surface of each of the clamping members, where the sealing surface is different from the clamping surface on each of the clamping members.

In yet another aspect of the invention, a sealing member to establish a seal between a pair of clamping members has a geometry such that the sealing member forms a closed loop about a longitudinal axis, and such that in a plane which includes the longitudinal axis, the sealing member has a cross-sectional shape which includes a plurality of segments oriented diagonally to the longitudinal axis in the plane to establish a seal between the clamping members, when the sealing member is engaged between the clamping members and a clamping force is applied.

Other aspects of the invention will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1A is a fragmental longitudinal sectional view of a sealing system of the invention illustrating positions of the parts prior to tightening the seal.

FIG. 1B is a magnified view of a portion of the sealing system in FIG. 1A.

FIG. 1C shows a partial, perspective cross-sectional view of a sealing system similar to that shown in FIGS. 1A and 1B.

FIG. 2 is a view similar to FIG. 1A illustrating positions of the parts after the seal is tightened.

FIG. 3A is a diagram that shows variation of the angle of inclination of the sealing member and direction of the compressive force.

FIG. 3B is a longitudinal sectional view of the sealing element of the invention.

FIG. 4 is a fragmental view of the seal of the invention showing a flat end face on the edge of the seal wall.

FIG. 5 is a fragmental view of the seal of the invention showing a rounded end face on the edge of the seal wall.

FIG. 6 is a fragmental view of the seal of the invention showing a beveled end face on the edge of the seal wall.

FIG. 7 shows a curved sealing element of the invention.

FIG. 8 shows a zigzag-shaped sealing element of the invention.

FIG. 9 is a cross-sectional view of the sealing member that has an oval transverse cross-section.

FIG. 10 is a cross-sectional view of the sealing member that has an ellipsoidal transverse cross-section.

FIG. 11 is a cross-sectional view of the sealing member that has a substantially circular, oval, or elliptical transverse cross-section.

FIG. 12 is a view similar to FIG. 2 showing a sealing member with irregularly shaped end faces.

FIG. 13 is a three-dimensional view of a sealing member having an irregular shape.

FIG. 14 is a side view of a sealing member according to another embodiment of the invention.

FIG. 15 is a sectional view similar to FIG. 1A illustrating an embodiment where the sealing member is made integrally with a first clamping member.

FIG. 16 is a sectional view similar to FIG. 1A illustrating an embodiment where the sealing member is made integrally with a second clamping member.

FIG. 17 shows an embodiment in which the sealing member has cross-sectional shape that includes multiple diagonals.

FIG. 18 shows an embodiment in which separate pieces of a softer material are affixed to the flanges at the corners where the sealing member contacts the flanges.

FIG. 19 shows an embodiment in which a tightening bolt applies a compression force to the vertex of a multi-diagonal sealing member through a solid cylinder.

FIG. 20 shows in cross-section a sealing member which has a cross-sectional shape that includes multiple segments oriented at different acute angles relative to the longitudinal axis.

FIG. 21 shows in cross-section a sealing member which has a cross-sectional shape that includes a segment which is not oriented diagonally to the longitudinal axis, disposed between two segments that are diagonal to the longitudinal axis.

### DETAILED DESCRIPTION

A sealing system is described herein. References in this specification to “an embodiment”, “one embodiment”, or the like, mean that the particular feature, structure or characteristic being described is included in at least one embodiment of the present invention. Occurrences of such phrases in this specification do not necessarily all refer to the same embodiment.

The sealing system introduced here is characterized by extreme simplicity of construction, converts the flange tightening force into a magnified sealing force, prevents occurrence of a virtual leak from a dead volume of the sealing unit, is simple to assembly, and reliable in operation. The sealing system introduced here is also characterized by extreme simplicity and low manufacturing cost.

In certain embodiments, the sealing system in a general case has a longitudinal axis and a plane P perpendicular thereto and comprising a first clamping member, a second clamping member, and a sealing member between said first clamping members and said second clamping member. The aforementioned sealing member is defined by a generatrix following a closed-loop curved line around the longitudinal axis, and in any partial cross section in a plane perpendicular to a projection of a tangent of the closed-loop curved line onto the plane P, the first clamping member has a first thrust point at a first distance from the longitudinal axis, and the second clamping member has a second thrust point at a second distance from the longitudinal axis. These distances are different. The first thrust point and the second thrust point are located at different levels along the longitudinal axis. The generatrix of the sealing member has a substantially diagonal shape in the form of a line connecting the first thrust point and the second thrust point. This line forms a shallow angle to the plane P, and when the first clamping member and the second clamping member are moved towards each other along the longitudinal axis and clamped together by a clamping force, the clamping force is magnified and converted into a compression force in the sealing member along the aforementioned line (or more precisely, the compression force is equal to the clamping force multiplied by a number greater than one (1)), the magnification being equal to the reciprocal of the sine of the shallow angle, causing the shallow angle to become even shallower, thus increasing the magnification.

According to a simplified embodiment, the system consists of two symmetrical interconnectable clamping or flanged members having flanges with cylindrical shoulders. Each shoulder forms a corner with its respective flange. The outer diameter of the shoulder of one of the flanged members is smaller than the inner diameter of the shoulder on the mating flanged member. The sealing element of the system comprises a hollow body of revolution (i.e., a ring-shaped structure), preferably from a thin-wall metal in the form of a truncated cone. The sealing element is placed between the clamping or flanged members so that in a longitudinal cross-section of the assembly the sealing element forms a diagonal between the apices of the corners formed between the flanges and their respective shoulders. This diagonal is inclined at an acute angle to a plane perpendicular to the longitudinal axis of the sealing device. In other words, the truncated-cone sealing element is arranged so that the edge of its smaller-diameter end face thrusts against the circular line of intersection of the first flange with its smaller diameter shoulder, while the edge of its larger-diameter end face thrusts against the circular line of intersection of the second flange with its larger diameter shoulder. When in the assembling operation the flanges move towards each other and tightened by bolts, studs, or the like, and the distance between the flanges is shortened, the truncated-cone seal is compressed in the aforementioned diagonal direction, i.e., in the direction of the conical wall of the seal, and the compression force is magnified as the compression progresses.

The sealing system of the last-mentioned embodiment operates in the same manner as described above for the general case. Since the seal is a body of revolution, at each radial cross-section of the sealing system the two flanges constrain the seal in such a way that the imaginary line between the contact points of the seal and the two flanges is at a shallow angle to a plane perpendicular to the axis of revolution. As the flanges are brought together when the seal is tightened, the aforementioned line undergoes rotation and compression. As a result, the compression force becomes much higher than the mating force (reciprocal to the sine of the angle), and the stresses (which are mainly radial, rather than axial) are borne by the flanges rather than by the mating bolts.

Thus, it can be seen that in the sealing assembly of the invention the sealing force is amplified by the geometry of the seal and flanges and reaches the magnitude many time greater than the force used to mate the flanges. The clamping members as well as the sealing member may have symmetrical or asymmetrical shapes, parallel or non-parallel end faces, flat or non-flat end faces, provided that the conditions described above are observed. The sealing member generatrix may have a linear, curved or zigzag configuration. In the first case the seal will work as a compressive seal, and in the other cases as a flexural seal.

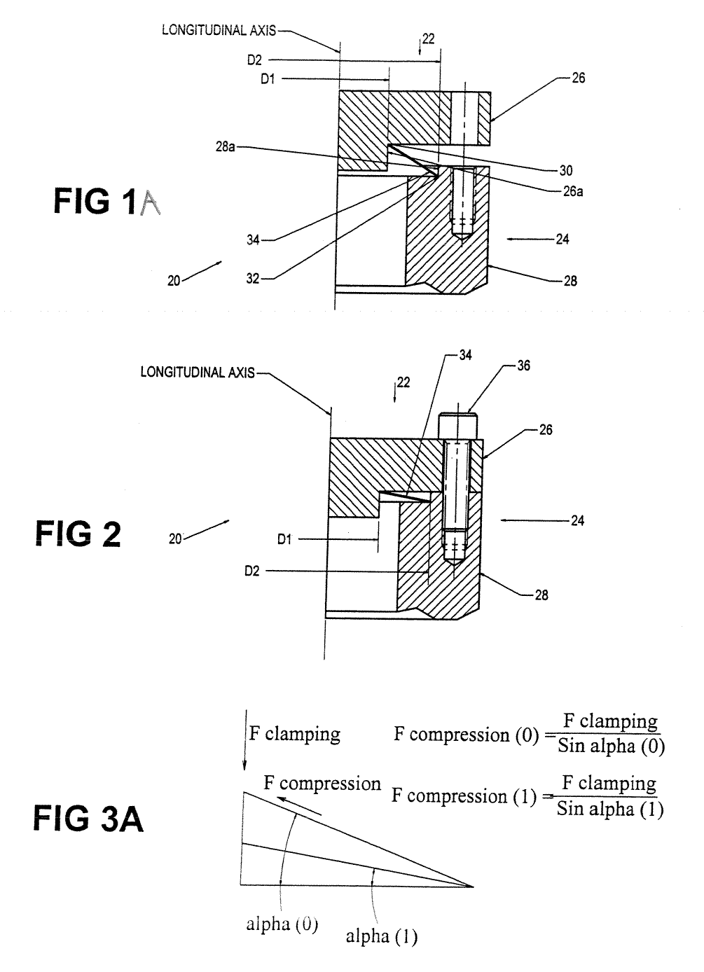

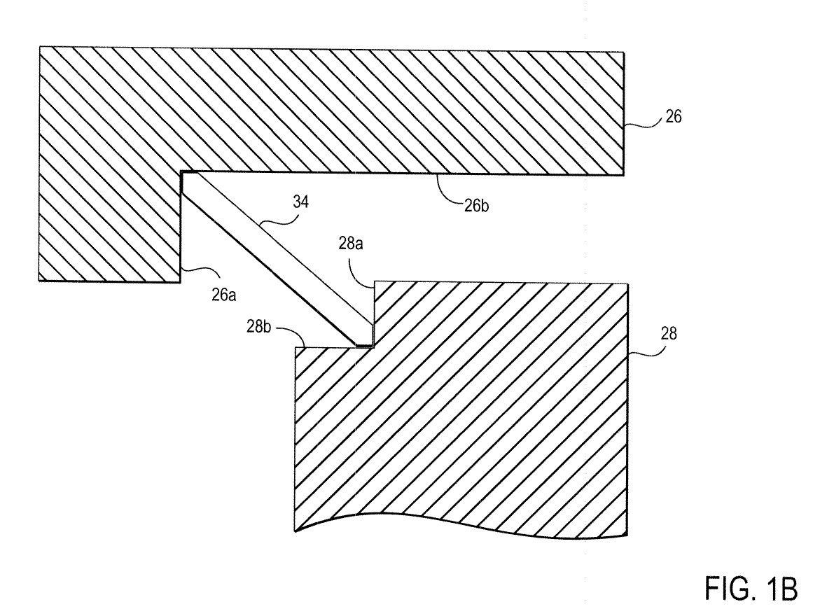

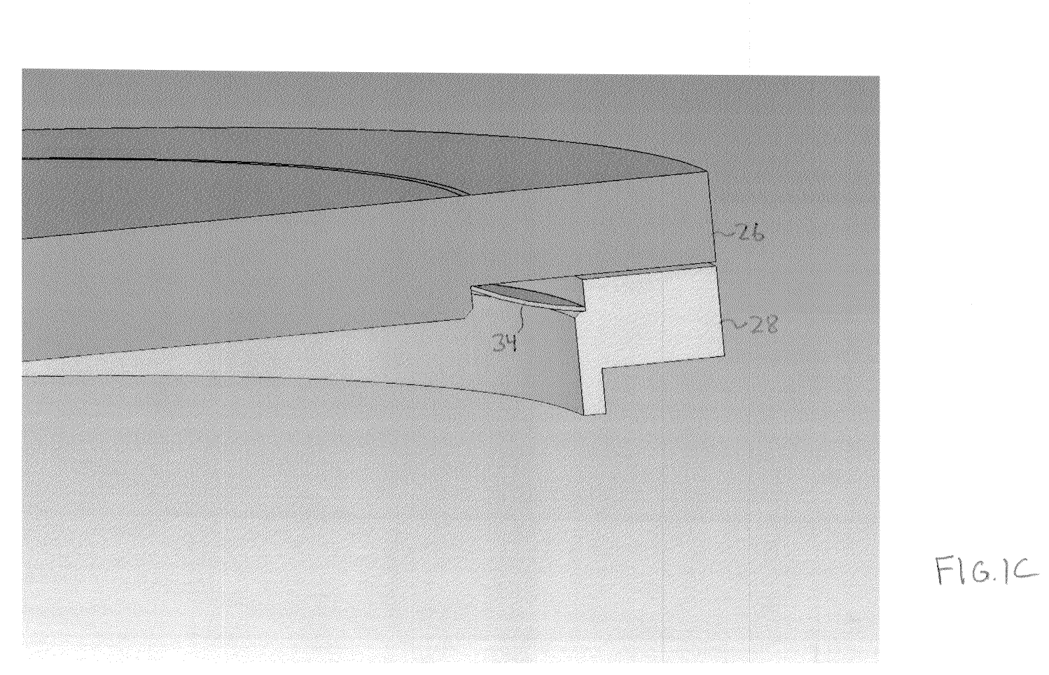

A sealing system according to one embodiment of the invention is shown in FIGS. 1A-1C and FIG. 2, where FIGS. 1A and 1B are fragmental longitudinal sectional views of a sealing system illustrating positions of the parts prior to tightening the seal, and FIG. 2 is a view similar to FIGS. 1A and 1B illustrating positions of the parts after the seal is tightened. FIG. 1C is a perspective fragmental sectional view of a sealing system similar to that shown in FIGS. 1A and 1B (with certain details not shown, such as the tightening bolts), after the seal is tightened. FIGS. 1A-1C and FIG. 2 show only the right half-part of the sealing system since the left half-part is symmetrical. In the embodiment of FIGS. 1A and 2, the sealing member has a regular shape and is made in the form of a truncated cone.

As can be seen from the drawings, the sealing system of FIGS. 1A and 2 that in general is designated by reference numeral 20 is characterized by extreme simplicity and low manufacturing cost. The system 20 consists of two interconnectable clamping or flanged members 22 and 24, hereinafter referred to as flanged members 22 and 24, having flanges 26 and 28 with cylindrical shoulders 26a and 28a. Each shoulder forms a corner with its respective flange. Thus, the flange 26 and its shoulder 26a form a corner area with the point of intersection designated by reference numeral 30. Hereinafter, this point of intersection will be referred to as a first thrust point 30. Similarly, the flange 28 and its shoulder 28a form a corner area with the point of intersection designated by reference numeral 32. Hereinafter, this point of intersection will be referred to as a second thrust point 32.

The first thrust point 30 of the flanged member 22 is located on a diameter D1 of the shoulder 26a which is smaller than the diameter D2 at location of the second thrust point 32 in the corner of the shoulder 28a of the flange member 24. In other words, the first thrust point 30 is located at a shorter distance from the longitudinal axis X-X of the sealing system 20 than the second thrust point 32.

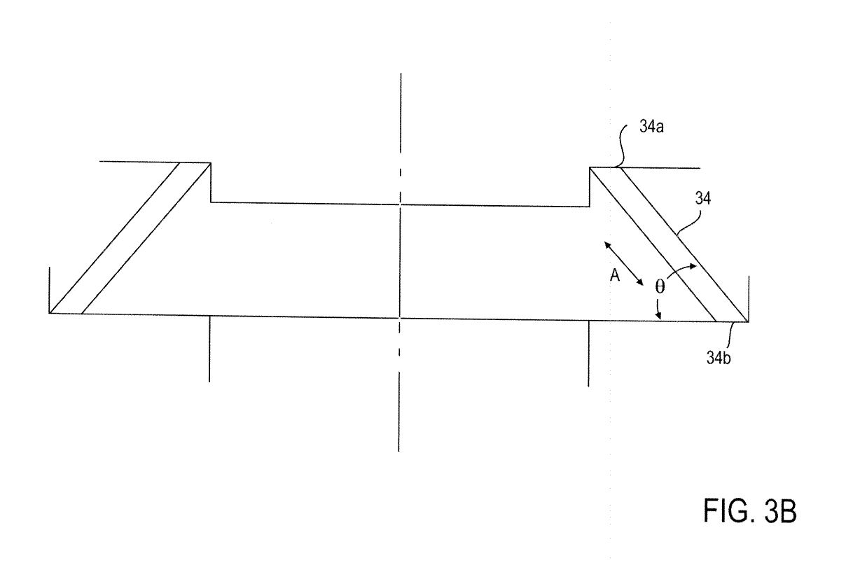

The heart of the system 20 is a sealing member 34, which is a body of revolution made, e.g., from a thin-wall metal, which in certain embodiments is in the form of a truncated cone that in a longitudinal cross section has a trapezoidal shape such as shown in FIG. 3B

The sealing member 34 is preferably made from a ductile material, such as aluminum, so that the sealing member is capable of undergoing plastic deformation on a macro-scale when the compression force is applied. This is in contrast with non-ductile materials, which are capable of elastic deformation only (short of failure), not plastic deformation. The ability of the sealing member 34 to undergo macro-scale and micro-scale plastic deformation effectively makes up for manufacturing tolerances on both levels of scale, thus providing a better seal. Furthermore, the sealing member 34 can maintain a high contact pressure on a wide dam.

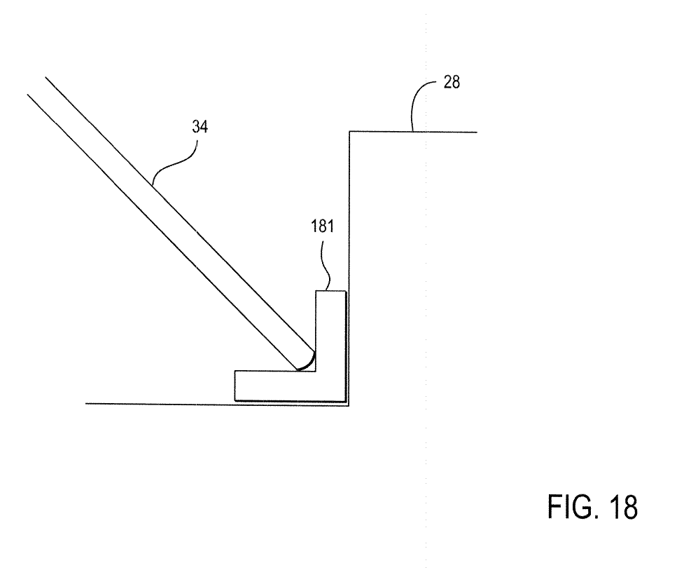

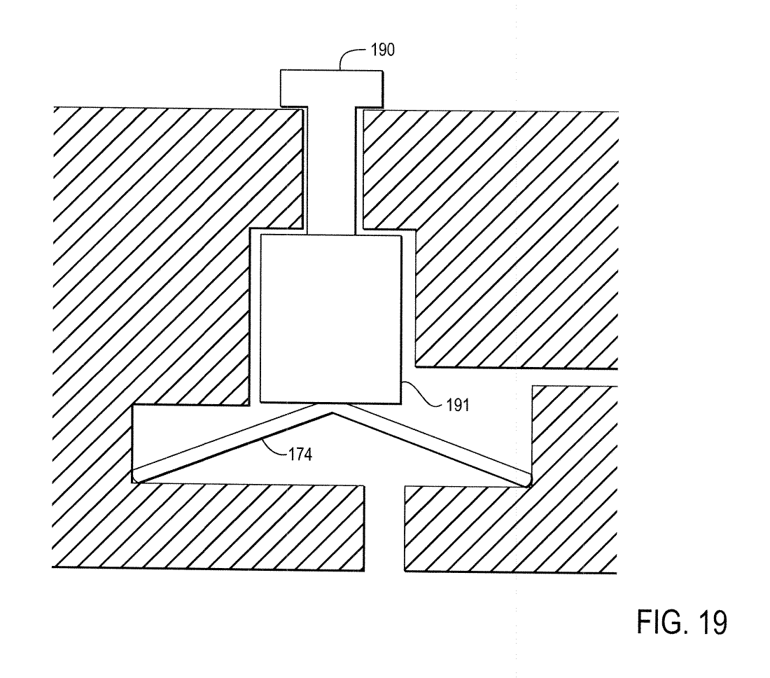

Alternatively, the sealing member can be made from a material which is stronger than aluminum, such as steel for example, which is also capable of bulk plastic deformation However, in the case of a harder material such as steel, it may be desirable to coat the sealing member 34 with a softer material, such as aluminum, to facilitate greater local plastic deformation at its ends. As yet another alternative, instead of coating the sealing member with a softer material, separate pieces 181 of a softer material (such as aluminum) can be affixed to the flanges 26 and 28 at the corners where the sealing member 34 contacts the flanges, as shown in FIG. 18.

The materials, dimensions and wall thickness of the sealing member 34 may vary in a wide range depending on a specific application of the sealing system, structure, materials, and dimensions of the flanged members, but in general the tapering angle α of the truncated cone may vary within the range of 1° to 89°, preferably, 10° to 20° with dimensions of the larger diameter from 12 mm to 2500 mm to and dimensional of the smaller diameter ranging from 12 mm to 2500 mm.

As shown in FIGS. 1A and 2, the sealing member 34 is placed between flanges 26 and 28 of the flanged members 22 and 24 so that the upper or smaller diameter end face 34a is brought in contact with the first thrust point 30, and the larger diameter end face is brought in contact with the second thrust point 32. During assembly of the system, the sealing member 34 is first placed onto the second flanged member 28 so that its lower or larger diameter end face 34b rests on the second shoulder 28b (the clamping surface of the second flanged member 28), and then the first flanged member 26 is placed from above with its face 26b (the clamping surface of the first flanged member 26) onto the upper or smaller diameter end face 34a of the sealing member 34. FIG. 1B is a slightly magnified view of the system in FIG. 1A.

In the embodiment of the invention shown in FIGS. 1A and 2, the flanges are tightened together by means of bolts, such as a bolt 36 shown in FIG. 2, that are inserted into aligned openings, such as openings 38 and 40 shown in FIG. 1, of which opening 40 has an internal thread for threaded engagement with the thread of the bolt 36. It is understood that such a tightening mechanism is shown only as an example and that the sealing system can be tightened to position of the parts shown in FIG. 2 by any other suitable means which are beyond the scope of the present invention.

It can be seen from FIG. 2 that in a closed state of the sealing system 20, the first thrust point 30 and the second thrust point 32 are located at different height level in the direction parallel to the longitudinal axis X-X. This feature, in combination with the fact that the thrust points 30 and 32 are located on different diameters, provides a shallow diagonal arrangement of the sealing member 34 between the flanged members 22 and 24 when the sealing member 34 is fixed and tightened in the operative position of the system shown in FIG. 2.

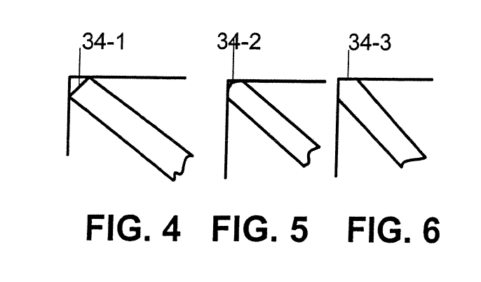

When in the assembling operation the flange members 22 and 24 move towards each other from the position of FIG. 1A to position of FIG. 2 and tightened by bolts, such as the bolt 36 (FIG. 2), or the like, and the distance between the flanges 26 and 28 is shortened, the truncated-cone sealing member 34 is compressed in the aforementioned diagonal direction, e.g., in the direction of the conical wall of the seal shown by arrow A in FIG. 3B. During tightening, the sealing member 34 is deformed and compressed, and the cone becomes shallower. The end faces of the sealing member 34 that are in contact with the thrust points 30 and 32 may be flat (an end face 34-1 in FIG. 4), rounded (an end face 34-2 in FIG. 5), or beveled (an end face 34-3 in FIG. 6). The deformation of the sealing member 34 caused by the tightening is plastic deformation, which occurs as a bulk (macro-scale) phenomenon; in other words, the plastic deformation occurs along the entire cross-sectional length of the sealing member (e.g., when viewed in a plane that includes the longitudinal axis). The sealing member 34 may also experience additional, local (micro-scale) plastic deformation at its ends which contact the flanges, as discussed above. This characteristic of the sealing member 34 makes up for manufacturing tolerances, as noted above.

The sealing system of the invention operates as follows. Since the sealing member 34 is a body of revolution (FIG. 3B), at each radial cross-section of the sealing system the two flanges 26 and 28 constrain the sealing member 34 in such a way that the imaginary line between the contact points of the seal and the two flanges is at a shallow angle α to a plane perpendicular to the axis of revolution, i.e., to the longitudinal axis X-X. As the flanges 26 and 28 are brought together when the sealing member 34 is tightened (FIG. 2), the aforementioned line between the contact points undergoes rotation and compression. As a result, the compression force becomes much higher than the tightening force of the bolts such as the bolt 36 (by a ratio reciprocal to the sine of said angle), and the stresses (which are radial, rather than axial) are borne by the faces (sealing surfaces) 26a and 28a of the flanges 26 and 28 (FIG. 1) rather than by the mating bolts.

It will be recognized from the above description that faces 26a and 28a of flanges 26 and 28, respectively, are the surfaces on which the actual seal is formed; therefore, they are also referred to as “sealing surfaces” 26a and 28, respectively. A “sealing surface”, as the term is used herein, is a surface on which a seal is formed. A “clamping surface”, as the term is used herein, is a surface (on a clamping member) that defines a plane that moves toward another clamping member when a clamping force is applied. Note that the sealing surfaces 26a and 28a are not the same surfaces as the clamping surfaces 26b and 28b in the embodiment described above. This is in contrast with prior art sealing systems, in which the sealing surfaces are also the clamping surfaces.

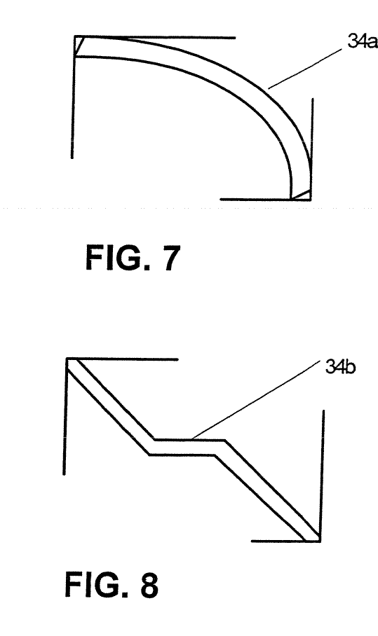

It has been shown that in the sealing system of FIGS. 1-3 the sealing force is amplified by the geometry of the sealing member 34 and flanges 26 and 28 and reaches the magnitude many time greater than the force used to mate the flanges. In the embodiment of the invention shown in FIGS. 1-6, the seal cone has a linear generatrix. However, if necessary, a sealing member 34a may have a curvilinear generatrix shown in FIG. 7 or a zigzag shaped generatrix shown in FIG. 8 for a sealing member 34b. In the first case (FIGS. 1-3) the sealing member 34 will work as a compressive seal, and in the case of sealing members 34a and 34b as a flexural seal.

Thus, it has been shown that in the embodiment of the sealing system shown in FIGS. 1-3, the system has a longitudinal axis X-X and comprises a first clamping member 22, a second clamping member 24, and a sealing member 34 that is clamped between both clamping members 22 and 24. The sealing member has a closed loop configuration, and in any partial cross-section (such as the cross-section shown in FIG. 2 that passes through the right part of the sealing assembly 20) the first and second clamping members 22 and 24 have respective thrust points 30 and 32 of contact with the sealing member 34. These points of contact are located at different distances D1 and D2 from the aforementioned longitudinal axis and at different levels along the longitudinal axis, so that in a position clamped between the clamping members 22 and 24 the sealing member 34 assumes a diagonal orientation in the form of a line that connects both thrust points 30 and 32. This line is inclined at an acute angle α to a plane perpendicular to the longitudinal axis X-X. The angle α is selected within such a range that a clamping force F_{clamping} developed when the clamping members are moved towards each other is converted and magnified in the sealing member into a compression force acting along the aforementioned line. As shown in FIG. 3A, as the clamping operation progresses, the angle α [alpha (0)] of inclination of the generatrix of the sealing member 34 to the plane perpendicular to the axis X-X is reduced to [alpha (1)] thus increasing the compressive force F_{compression}. This is because the magnification of the compressive force F_{compression}, the direction of which is shown in FIG. 3A by the arrow, is in inverse proportion to the sine of the aforementioned acute angle α. This can be written by the following formula:
F_{compression}=F_{clamping}/Sin α

In one specific example of the sealing system of FIGS. 1-3, the elements of the sealing system had the following dimension: D1=135 mm, D2=150 mm, angle α=18°. The wall thickness was 1.3 mm. The pressure (vacuum) in the container was 10E⁻⁹ Torr.

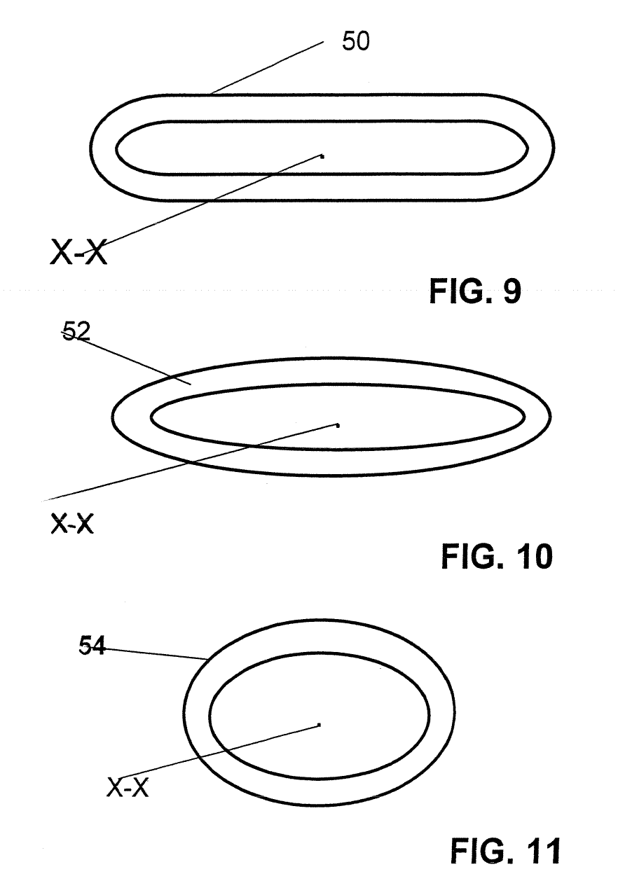

The invention has been described above in the form of a system with symmetrical components, such as regularly shaped symmetrical clamping members and the sealing member, where in a cross-section the seal has a circular configuration. However, the invention is not limited to such an application and the seal may have any other closed-loop configuration in the cross-section perpendicular to the longitudinal axis X-X. For example, a sealing member 50 shown in FIG. 9 may have an oval cross-sectional configuration, a sealing member 52 shown in FIG. 10 may have an ellipsoidal cross-sectional configuration, and a sealing member 54 shown in FIG. 11 may have a substantially circular, substantially oval, or substantially ellipsoidal configuration. The term substantially means that in a cross-sectional configuration the sealing member may not be geometrically strictly circular, oval, or ellipsoidal but rather close to such geometrical shapes.

In a longitudinal cross-section, the sealing system with sealing members 50, 52, and 54 will have the same configuration as shown in FIGS. 1-8. In other words, the sealing system will have the longitudinal axis X-X, will contain a first clamping member such as the member 22, a second clamping member such as the member 24; and a sealing member, e.g., 50, between the first claming member 22 and the second clamping member 52 made, e.g., from a thin-walled metal. In the longitudinal cross section, the first clamping member 22 has a pair of first thrust points arranged symmetrically with respect to each other at first distances (only one such point 30 is shown in FIG. 1A at a distance D1 from the axis X-X as the image corresponds only to a half of the system 20) and the second clamping member 24 has a second pair of thrust points arranged symmetrically with respect to each other at second distances (only one such point 32 is shown in FIG. 1A at a distance D2 from the axis X-X as the image corresponds only to a half of the system 20). The distances D1 and D2 are different and are located at different levels along axis X-X. In a longitudinal cross-section of the system 20 in an assembled state shown in FIG. 2, any of the sealing members 50, 52, and 54 will assume a substantially diagonal position in the form of a diagonal 34 between the first thrust points such as 30 and the second thrust points such as 32, and when the first clamping member 22 and the second clamping member 24 are clamped together by a clamping force (not shown) acting in the direction of axis X-X or parallel to this direction, this clamping force will be converted into a force that compresses the sealing member in the direction of the diagonals such as the diagonal 34.

In the embodiments of FIGS. 9-11, the sealing member has a closed-loop configuration, and in any partial cross section that may pass through the aforementioned longitudinal axis X-X (that is shown as a central dot in FIGS. 9-11) the first and second clamping members will have thrust points located at different distances from the aforementioned longitudinal axis and at different levels along the longitudinal axis (the thrust point and their distances from the axis X-X are now shown as the devices of the FIGS. 9-11 will have the same longitudinal cross-sectional views as those shown in FIGS. 1A and 2.)

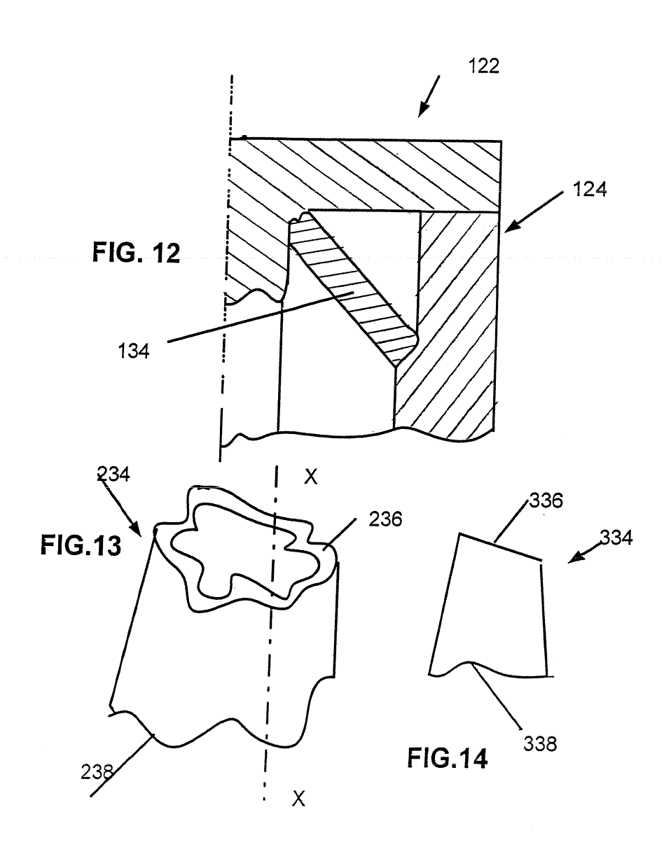

The invention is not limited in its application only to symmetrical or/and regularly shaped components of the sealing system, and the clamping members as well as the sealing member may have any arbitrary irregular and asymmetrical shape, e.g., of the types shown in FIGS. 12-14, where FIG. 12 is a view similar to FIG. 2 that shows a partial longitudinal sectional view of the sealing system having irregularly shaped system components. Thus, FIG. 12 shows irregularly shaped clamping members 122 and 124 and an irregularly shaped sealing member 134. FIG. 13 shows an asymmetrical and irregularly shaped sealing member 234 with uneven upper and lower end faces 236 and 238, the axis X-X is offset from the central part of the sealing member 234. FIG. 14 is a side view of a sealing member 334 with non-parallel end faces, of which an end face 336 is smooth and an end face 338 is uneven, both end faces being inclined to the axis at angles different from 90° C.

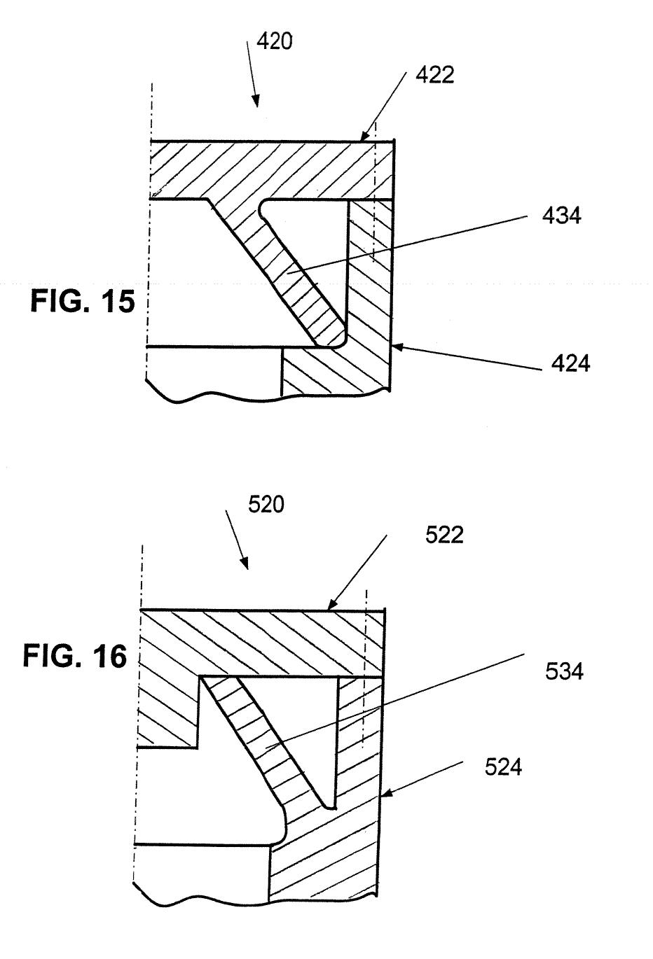

The sealing member of any of the above-described embodiments can be made integrally with any of the clamping members. FIG. 15 is a sectional view similar to FIG. 2 illustrating an embodiment of a system 420 where the sealing member 434 is made integrally with a first clamping member 422. Reference numeral 424 designates the second clamping member.

FIG. 16 is a sectional view similar to FIG. 2 illustrating an embodiment of a sealing system 520 where the sealing member 534 is made integrally with a second clamping member 524. Reference numeral 522 designates the first clamping member.

It has been shown that the principle of the invention is observed in all embodiments, provided that the sealing member has a closed-loop configuration around the longitudinal axis X-X and that in any partial cross section in a plane perpendicular to a projection of a tangent of the closed-loop curved line onto the plane perpendicular to the longitudinal axis, the first clamping member has a first thrust point at a first distance from the longitudinal axis, and the second clamping member has a second thrust point at a second distance from the longitudinal axis. These distances are different, and the thrust points are located at different levels along the longitudinal axis.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, the shape of the clamping members and the sealing element may be different from those shown in FIGS. 1-16, provided that the principles of the invention formulated above and in the claims are observed. The shape can be solid or hollow, the latter can be empty or filled with another material. What is meant under the term “flanged members” is not necessarily casing parts or covers with flanges but any parts that have means for clamping them together with diagonal arrangement of the generatrix of the seal between two thrust points. Sealing of high pressure, high temperature piping joints may employ a plurality of the sealing elements with outer and inner tubular spacers between them. The sealing element can be a relatively rigid core to take the compression force, coated by a softer material for the actual seal. The sealing edges 34a and 34b in FIGS. 1 and 2 can be shaped to act with faces 26a and 28 and to further reduce the potential for a virtual leak.

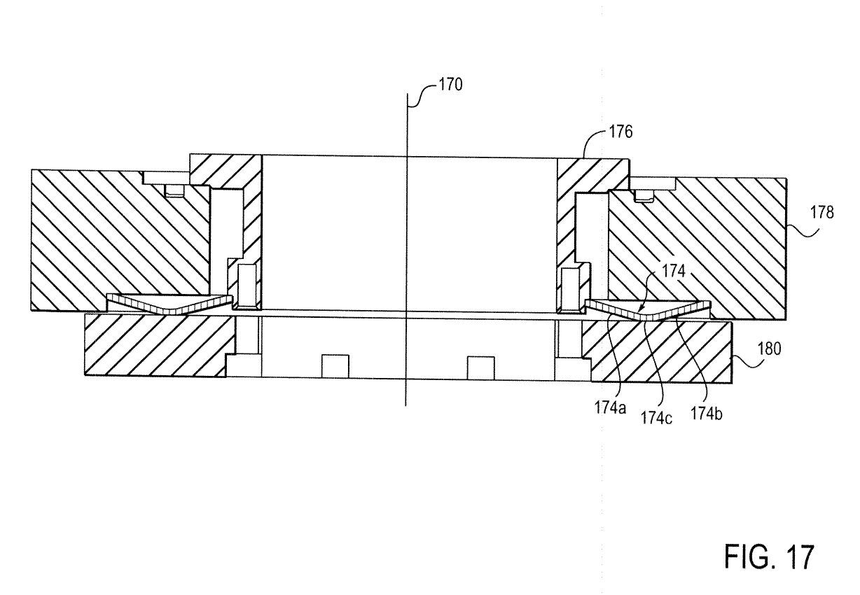

In at least some embodiments of the invention, such as illustrated in FIGS. 1A and 1B, the sealing member 34 has a cross-sectional shape that is a segment oriented diagonally to (i.e., at an acute angle with respect to) the longitudinal axis, in any plane which includes the longitudinal axis 170. FIG. 17 shows another embodiment of a sealing system in accordance with the invention, in which the sealing member has a cross-sectional shape that includes two contiguous diagonal segments. In the embodiment of FIG. 17, the sealing member 174 has a cross-sectional shape that can be described as two contiguous, substantially linear segments 174a and 174b of substantially equal length, oriented diagonally to the longitudinal axis (and at an obtuse angle to each other) in any plane which includes the longitudinal axis 170. The two segments 174a and 174b meet at a vertex 174c about halfway along the cross-sectional width of the sealing member 174. Note that references here to multiple “segments” are for purposes of describing the shape of the sealing member 174 and do not mean that the sealing member 174 must be formed from separate pieces; to the contrary, the sealing member 174 is preferably formed from a single piece of material.

In the embodiment of FIG. 17, the flanges 176 and 178 and a forcing member 180 are first mated together with the sealing member “trapped” inside, and only then are the parts tightened to make the seal. The seal is created by tightening fasteners (e.g., screws, bolts, or the like) through flange 176 and forcing member 180. This action causes forcing member 180 and flange 176 to move toward each other, applying the clamping force at the vertex 174c and each end of the sealing member 174. This action compresses the sealing member 174, creating a compression force along the sealing member and forcing one end of the sealing member 174 against flange 176 and the other end of the sealing member 174 against flange 178, to create the seal. As with the embodiments described above, the compression force is much larger than the clamping force, based on the same geometric principle discussed above.

As with embodiments described above, the sealing member 174 can work in pure compression, or in a combination of compression and flexure. The rigidity of the seal depends on the shape of the sealing member in cross-section. A sealing member with straight (substantially linear) segments such as shown in FIG. 17 will work mostly in compression, whereas a sealing member with curved segments such as shown in FIG. 7 will work mostly in bending.

As a variation of the embodiment in FIG. 17, the same set of fasteners can be used both to do the mating and to apply the compression force to the sealing member. For example, instead of using a forcing member 180 to apply the compression force, the fasteners which tighten flanges 176 and 178 together could be used to apply the compression force directly or, as shown in FIG. 19, indirectly to the vertex 174c of sealing member 174. In the example of FIG. 19, the tightening bolt 190 applies a compression force to the vertex of the sealing member 174 through a solid cylinder 191.

Note that in other variations of the embodiment in FIG. 17, the sealing member may have more than two contiguous diagonal segments (in cross-section).

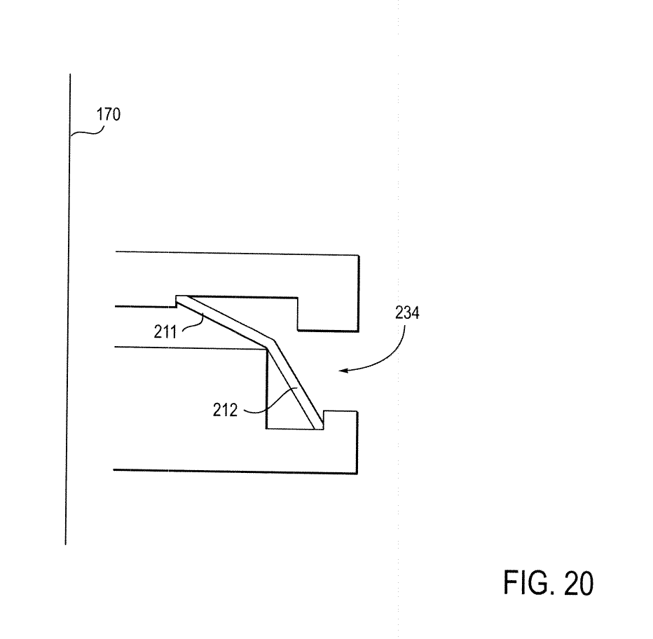

FIGS. 17 and 19 show embodiments in which the segments of the sealing member are oriented at equal acute angles relative to the longitudinal axis 170. FIG. 20 shows an alternative embodiment, in which the segments 211 and 212 of a sealing member 234 are oriented at different acute angles relative to the longitudinal axis 170, i.e., the sealing member 234 has a boomerang-like cross-sectional shape in a plane which includes the longitudinal axis.

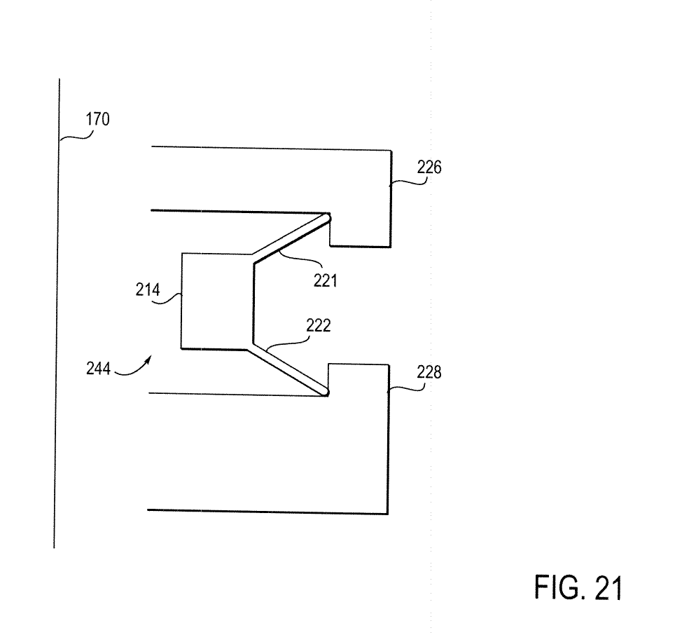

In the embodiments shown in FIGS. 17, 19 and 20, the multiple diagonal segments are contiguous. As an alternative, however, a sealing member can include one or more segments, which are not oriented diagonally to the longitudinal axis, disposed between the two or more segments that are diagonal to the longitudinal axis, in a plane which includes the longitudinal axis. An example of such an embodiment is shown in FIG. 21, in which the sealing member 244 has a shape similar to the letter “K” in cross-section. More specifically, the sealing member 244 has a middle segment 214, which is essentially aligned with the longitudinal axis 170, disposed between two diagonal segments 221 and 222, in a plane which includes the longitudinal axis 170. Note that the sealing member 244 is supported by flanges 226 and 228 making contact with the ends of the diagonal segments 221 and 222 when the system is assembled.

Of course, other variations in shape and construction of the sealing member and clamping members are possible, consistent with the principles described above.

Thus, a sealing system has been described. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A sealing member to establish a seal between a pair of clamping members, the sealing member having a geometry such that the sealing member forms a closed loop about a longitudinal axis, the geometry of the sealing member being such that the sealing member forms a seal on a sealing surface of each of the clamping members when the sealing member is engaged between the clamping members and a clamping force is applied parallel to the longitudinal axis, the geometry of the sealing member further being such that the sealing member causes a compression force which is greater than the clamping force to be applied between the sealing member and the sealing surface of each clamping member when the clamping force is applied, the sealing member having a cross-sectional length in a plane which includes the longitudinal axis, and wherein the sealing member is capable of plastic deformation along substantially the entire cross-sectional length in response to the clamping force.

2. A sealing member as recited in claim 1, wherein the geometry of the sealing member further is such that the compression force has a non-zero force component perpendicular to the longitudinal axis.

3. A sealing member as recited in claim 1, wherein the sealing member is a body of revolution with respect to the longitudinal axis.

4. A sealing member as recited in claim 1, wherein the geometry of the sealing member further is such that the sealing member engages, on each of the clamping members, a clamping surface which moves toward the clamping surface of the other clamping member when the sealing member is engaged between the clamping members, and such that the sealing surface is different from the clamping surface on each of the clamping members.

5. A sealing member to establish a seal between a pair of clamping members, the sealing member having a geometry such that, when the sealing member is engaged between the clamping members and a clamping force is applied, the sealing member engages, on each of the clamping members, a clamping surface which moves toward the clamping surface of the other clamping member, and such that the sealing member forms a seal on a sealing surface of each of the clamping members, the sealing surface being different from the clamping surface on each of the clamping members.

6. A sealing member as recited in claim 5, wherein in a plane, the sealing member has a cross-sectional length defined between the clamping members, and wherein the sealing member is capable of plastic deformation along substantially the entire cross-sectional length in response to the clamping force.

7. A sealing member as recited in claim 5, wherein geometry of the sealing member further is such that the sealing member forms a closed loop around a longitudinal axis.

8. A sealing member as recited in claim 7, wherein the sealing member is a body of revolution with respect to the longitudinal axis.

9. A sealing member as recited in claim 5, wherein the sealing member causes a compression force to be applied between the sealing member and the sealing surfaces of the clamping members when the clamping force is applied, wherein the compression force is greater than the clamping force.

10. A sealing member as recited in claim 5, wherein the sealing member causes a compression force to be applied between the sealing member and the sealing surfaces of the clamping members when the clamping force is applied, the compression force having a non-zero force component perpendicular to the longitudinal axis.

11. A sealing member as recited in claim 10, wherein the compression force is greater than the clamping force.

12. A sealing system comprising:
a pair of clamping members; and
a sealing member engaged to form a seal between the clamping members when a clamping force is applied along a longitudinal axis, the sealing member having a geometry such that the sealing member forms a closed loop around a longitudinal axis, the sealing member engaging a clamping surface on each of the clamping members, the geometry of the sealing member further being such that the sealing member causes a compression force which is greater than the clamping force to be applied between the sealing member and a sealing surface of each clamping member when the clamping force is applied, the sealing member having a cross-sectional length in a plane which includes the longitudinal axis, and wherein the sealing member is capable of plastic deformation along substantially the entire cross-sectional length in response to the clamping force.

13. A sealing system as recited in claim 12, wherein the compression force has a non-zero force component perpendicular to the longitudinal axis.

14. A sealing system as recited in claim 12, wherein the sealing surface is different from the clamping surface on each of the clamping members.

15. A sealing system as recited in claim 12, wherein the sealing member is a body of revolution with respect to the longitudinal axis.

16. A sealing member to establish a seal between a pair of clamping members, the sealing member having a geometry such that the sealing member forms a closed loop about a longitudinal axis, and such that in a plane which includes the longitudinal axis, the sealing member has a cross-sectional shape which includes a plurality of segments, each oriented diagonally to the longitudinal axis in said plane, to establish a seal between the clamping members when the sealing member is engaged between the clamping members and a clamping force is applied.

17. A sealing member as recited in claim 16, wherein the geometry of the sealing member is such that when the clamping force is applied, at least one of the segments causes a compression force to be applied to a sealing surface of a corresponding one of the clamping members.

18. A sealing member as recited in claim 17, wherein the compression force is greater than the clamping force.

19. A sealing member as recited in claim 16, wherein the sealing member has a cross-sectional length in said plane which includes the longitudinal axis, and wherein the sealing member is capable of plastic deformation along substantially the entire cross-sectional length in response to the clamping force.

20. A sealing member as recited in claim 16, wherein the plurality of segments include two segments which meet at a vertex, oriented such that when the clamping force is applied at the vertex parallel to the longitudinal axis, at least one of the segments converts the clamping force into a compression force applied along the segment to a corresponding one of the clamping members.

21. A sealing member as recited in claim 20, wherein the two segments are oriented such that when a clamping force is applied at the vertex parallel to the longitudinal axis, each of the two segments converts the clamping force into a compression force applied along the segment to a separate corresponding one of the clamping members.

22. A sealing member as recited in claim 16, wherein the sealing member is a body of revolution with respect to a longitudinal axis.

23. A sealing member as recited in claim 16, wherein the geometry of the sealing member further is such that the sealing member forms a seal on a sealing surface of each of the clamping members when the sealing member is engaged between the clamping members and the clamping force is applied, wherein the sealing surface on each of the clamping members remains stationary when the clamping force is applied to establish the seal.

24. A sealing member as recited in claim 23, wherein the clamping members remain stationary when the clamping force is applied to establish the seal.

25. A sealing member as recited in claim 16, wherein said plurality of segments are contiguous.

26. A sealing member as recited in claim 16, further comprising a segment which is not oriented diagonally to the longitudinal axis, disposed between said plurality of segments which are oriented diagonally to the longitudinal axis.
